(19) United States
(12) Patent Application Publication
(10) Pub. No.: US 2012/0244303 A1
(43) Pub. Date: Sep. 27, 2012

(54) RIGID PU FOAM HAVING A LOW THERMAL CONDUCTIVITY AND GOOD THERMAL STABILITY

(75) Inventors: Gianpaolo TOMASI, Diepholz (DE); Christof Grieser-Schmitz, Osnabrueck (DE); Ludwig Windeler, Marl (DE); Carsten Ellersiek, Lengerich (DE); Gunnar Kampf, Stemwede-Haldem (DE)

(73) Assignee: BASF SE, Ludwigshafen (DE)

(21) Appl. No.: 13/423,503

(22) Filed: Mar. 19, 2012

Related U.S. Application Data
(60) Provisional application No. 61/466,021, filed on Mar. 22, 2011.

(51) Int. Cl. B32B 1/08; C08G 18/06

(52) U.S. Cl. 428/36.5; 521/164

(57) ABSTRACT

The present invention relates to a polyurethane foam which can be obtained by reacting at least one polyether polyol as component (A), at least one polyether polyol based on at least one amine as component (B), at least one polyester polyol as component (C) and at least one polyisocyanate as component (D), in the presence of at least one catalyst selected from the group consisting of salts of carboxylic acids having from 1 to 20 carbon atoms, amine-comprising compounds and mixtures thereof as component (E) and at least one blowing agent as component (F), wherein the ratio of OCN groups to OH groups (ISO index) is from 140 to 180. The present invention further relates to a process for producing said polyurethane foam, its use for insulation, in particular for the insulation of pipes, and also pipe insulation comprising a polyurethane foam according to the invention.

The present invention relates to a polyurethane foam which can be obtained by reacting at least one polyether polyol as component (A), at least one polyether polyol based on at least one amine as component (B), at least one polyester polyol as component (C) and at least one polyisocyanate as component (D), in the presence of at least one catalyst selected from the group consisting of salts of carboxylic acids having from 1 to 20 carbon atoms, amine-comprising compounds and mixtures thereof as component (E) and at least one blowing agent as component (F), wherein the ratio of OCN groups to OH groups (ISO index) is from 140 to 180. The present invention further relates to a process for producing said polyurethane foam, its use for insulation, in particular for the insulation of pipes, and also pipe insulation comprising a polyurethane foam according to the invention.

Polyurethane foams which can be used for the insulation of pipes are already known from the prior art.

US 2006/0052467 discloses a polyol composition which is suitable for processing with appropriate polyisocyanates to give foams.

DE 10 2004 001 317 A1 discloses polyurethane foams for pipe insulation. These polyurethane foams can be obtained by reacting an isocyanate component (a) with a polyol mixture (b), wherein the polyol mixture comprises polyols having a hydroxyl number of greater than 70 mg KOH/g and has a viscosity of less than 3000 mPa·s, measured in accordance with DIN 53019 at 20° C. This document generally discloses that compounds having at least two groups which are reactive toward isocyanate are possible as polyols. Examples are compounds having OH groups, SH groups, and/or NH₂ groups.

EP 1 288 239 A1 discloses a process for producing solid urethane-polyisocyanurate foams. These comprise various polyol polyethers.

WO 98/37116 likewise discloses a process for producing solid polyurethane foams by reacting a polyisocyanate component with a mixture of polyol components. According to this document, the polyisocyanate component is a polymethylenepolyphenyl polyisocyanate compound or a derivative thereof. The mixture of polyol components comprises a polyol which is obtained by binding an alkylene oxide to an aliphatic amine and an aromatic polyether polyol which is obtained by binding an alkylene oxide to an aromatic amine.

US 2003/0134923 A1 likewise discloses polyurethane foams comprising the reaction product of an organic polyisocyanate and a polyester polyol.

WO 2005/090432 A1 discloses a process for producing solid polyurethane foams having an isocyanate index of from 110 to 120 by reacting an organic polyisocyanate composition with a mixture which is reactive toward isocyanate groups. Apart from polyester polyols, polyetherols based on aromatic amines are also present in the reaction mixture described.

EP 1 735 365 B1 discloses polyurethanes and a process for producing them. For this purpose, an organic polyisocyanate composition is reacted with a composition which is reactive toward isocyanate groups and comprises, for example, polyether polyols or polyester polyol polyols.

WO 00/63276 A1 discloses a polyol mixture for producing rigid polyurethane foams. This mixture comprises addition products of alkylene oxides onto aromatic diamines or polyamines. A polyester polyol polyol can also be present as compounds which are reactive toward isocyanate groups.

The polyurethane foams known from the prior art are still in need of improvement in respect of the thermal conductivity and their thermal behavior. In particular, the thermal conductivity of the polyurethane foams according to the prior art can be reduced without the thermal stabilities being impaired.

In the light of the prior art, it is therefore an object of the present invention to provide a polyurethane foam which has a particularly balanced and thus advantageous property profile in respect of thermal conductivity and thermal stability. A polyurethane foam which has a particularly low thermal conductivity should be provided since the polyurethane foam according to the invention is to be used, for example, as insulation, in particular as pipe insulation. Apart from a low thermal conductivity, the polyurethane foam of the invention should have good thermal stability.

These objects are achieved according to the invention by a polyurethane foam which can be obtained by reacting

(A) at least one polyether polyol as component (A),
(B) at least one polyether polyol based on at least one amine as component (B),
(C) at least one polyester polyol as component (C) and
(D) at least one polyisocyanate as component (D)
in the presence of at least one catalyst selected from the group consisting of salts of carboxylic acids having from 1 to 20 carbon atoms, amine-comprising compounds and mixtures thereof as component (E) and at least one blowing agent as component (F), wherein the ratio of OCN groups to OH groups (ISO index) is from 140 to 180.

Furthermore, the objects are achieved by a process for producing a polyurethane foam according to the invention, which comprises at least the following steps:
(I) contacting of the components (A), (B), (C), (D), (E) and (F) to give a reaction product and
(II) foaming of the reaction product obtained in step (I).

The objects are also achieved by the use of the polyurethane foam of the invention for insulation, and by an insulated pipe comprising a polyurethane foam according to the invention.

The individual components of the polyurethane foam of the invention are described in detail below:

Component (A):

At least one polyether polyol is present as component (A) in the polyurethane foam according to the invention. For the purposes of the present invention, all polyether polyols known to those skilled in the art are generally suitable as component (A).

Preference is given to using a polyether polyol based on at least one polyhydric alcohol as component (A).

According to the invention, polyether polyols having at least two hydrogen atoms which are reactive toward isocyanate, preferably polyether polyols having OH numbers in the range from 100 to 1200 mg KOH/g, are preferably used as component (A).

The polyether polyols which are preferably used have, for example, a functionality in the range from 2 to 8, in particular from 3 to 8.

Polyether polyols which are preferably used as component (A) are prepared by methods known to those skilled in the art, for example, by anionic polymerization of alkylene oxides in the presence of catalysts, preferably alkali metal hydroxides.

As alkylene oxides, use is usually made of ethylene oxide and/or propylene oxide, preferably pure 1,2-propylene oxide.

Starter molecules used are, in particular, compounds having at least 2, preferably from 3 to 8, hydroxyl groups in the molecule.

As starter molecules having at least 2, preferably from 3 to 8, hydroxyl groups in the molecule, preference is given to using trimethylolpropane, glycerol, pentaerythritol, sugar compounds such as glucose, sorbitol, mannitol and sucrose, polyhydric phenols, resols, such as oligomeric condensation products of phenol and formaldehyde and Mannich condensates of phenols, formaldehyde and dialkanolamines and also melamine.

The present invention therefore preferably provides the polyurethane foam of the invention in which the at least one polyether polyol (component (A)) is based on at least one compound selected from the group consisting of trimethylolpropane, glycerol, pentaerythritol, sugar compounds such as glucose, sorbitol, mannitol and sucrose, polyhydric phenols, resols, such as for example oligomeric condensation products of phenol and formaldehyde and Mannich condensates of phenol, formaldehyde and dialkanolamines, melamine and mixtures thereof.

The polyether polyols used as component (A) have a functionality of preferably from 3 to 8. Furthermore, the polyether polyols used as component (A) have hydroxyl numbers of preferably from 100 mg KOH/g to 1200 mg KOH/g and in particular from 240 mg KOH/g to 570 mg KOH/g.

In a preferred embodiment, a mixture of 2, 3, 4 or 5 polyether polyols which differ, for example in terms of the starter molecule and/or the alkylene oxides used is used as component (A).

For example, a mixture comprising at least one polyether polyol based on a polysaccharide sugar as component (a1)) is used as component (A). The polysaccharide sugar is preferably sucrose.

In a preferred embodiment, the polyether polyols used as component (a1)) are not exclusively based on at least one polysaccharide sugar but instead a plurality of polyhydric alcohols, for example selected from among pentaerythritol and/or diethylene glycol, are used as bases.

The polyether polyol used as component (a1)) has, for example, an OH number of from 100 to 700 mg KOH/g, preferably from 200 to 600 mg KOH/g, particularly preferably from 300 to 500 mg KOH/g, very particularly preferably from 350 to 450 mg KOH/g.

In a further preferred embodiment, the polyether polyol used as component (a1) has an average functionality of, for example, from 2 to 6, preferably from 3 to 5, particularly preferably from 3.5 to 4.5.

In the mixture of polyether polyols which is preferably used as component (A) a further polyether polyol based on at least one monosaccharide sugar (a2) is preferably present.

A monosaccharide sugar, on which component (a2) is based, is, for example, sorbitol.

The polyether polyol used as component (a2) has, for example, an OH number of from 200 to 800 mg KOH/g, preferably from 300 to 700 mg KOH/g, particularly preferably from 400 to 600 mg KOH/g, very particularly preferably from 450 to 550 mg KOH/g.

In a further preferred embodiment, the polyether polyol used as component (a2) has an average functionality of, for example, from 3 to 7, preferably from 4 to 6, particularly preferably from 4.5 to 5.5.

As further polyether polyol, which is present in the mixture of polyether polyols which is preferably used as component (A), at least one polyether polyol based on at least one at least dihydric alcohol is preferably present as component (a3) in the mixture.

The at least dihydric alcohols present in component (a3) can be dihydric, trihydric, tetrahydric or pentahydric, i.e. they comprise two, three, four or five hydroxy groups per molecule.

A particularly preferred at least dihydric alcohol present in component (a3) is, for example, glycerol.

In a further preferred embodiment, the polyether polyol used as component (a3) has an OH number of, for example, from 500 to 1100 mg KOH/g, preferably from 600 to 1000 mg KOH/g, particularly preferably from 700 to 900 mg KOH/g.

In a further preferred embodiment, the polyether polyol used as component (a3) has an average functionality of, for example, from 1 to 5, preferably from 2 to 4, particularly preferably from 2.5 to 3.5.

In a particularly preferred embodiment, a mixture comprising at least one polyether polyol based on a polysaccharide sugar (a1), at least one polyether polyol based on a monosaccharide sugar (a2) and at least one polyether polyol based on at least one at least dihydric alcohol (a3) is used as component (A) in the polyurethane foam of the invention.

The present invention therefore preferably provides the polyurethane foam of the invention in which a mixture comprising at least one polyether polyol based on a polysaccharide sugar (a1), at least one polyether polyol based on a monosaccharide sugar (a2) and at least one polyether polyol based on at least one at least dihydric alcohol (a3) is used as component (A).

Component (A) is generally present in an amount of from 10 to 60% by weight, preferably from 20 to 50% by weight, particularly preferably from 25 to 45% by weight, in each case based on the sum of components (A), (B), (C) and (E), in the polyurethane foam of the invention. If a mixture of various polyether polyols is used as component (A), the amounts specified are based on this mixture.

The sum of the components (A), (B), (C) and (E) is, according to the invention, always 100% by weight.

Component (B):

At least one polyether polyol based on at least one amine is present as component (B) in the polyurethane foam of the invention. For the purposes of the present invention, all polyether polyols which satisfy the specified conditions are generally suitable as component (B).

The amines present in component (B) are, for example, selected from the group consisting of amines having at least two primary amino groups in the molecule, with preference being given to using aromatic diamines and/or polyamines, for example phenylenediamines, 2,3-, 2,4-, 3,4- and 2,6-toluenediamine or 4,4′-, 2,4′- and 2,2′-diaminodiphenylmethane and also aliphatic diamines and polyamines, such as ethylenediamine.

Toluenediamine (TDA) is preferably used as starter molecule for component (B), with one of the isomers mentioned or a mixture of the isomers mentioned being able to be used.

The present invention therefore preferably provides a polyurethane foam according to the invention in which the at least one amine in component (B) is toluenediamine (TDA).

Component (B) of the polyurethane foam of the invention is obtained, for example, by reacting an alkylene oxide, for example selected from the group consisting of tetrahydrofuran, ethylene oxide, propylene oxide, 1,2- or 2,3-butylene oxide, styrene oxide and mixtures thereof, preferably a mixture of ethylene oxide and propylene oxide, with the abovementioned amines. Reaction conditions for this reaction are known per se to those skilled in the art.

In a further preferred embodiment, the polyether polyol used as component (B) has an OH number of, for example, from 100 to 700 mg KOH/g, preferably from 200 to 600 mg KOH/g, particularly preferably from 300 to 500 mg KOH/g, very particularly preferably from 350 to 450 mg KOH/g.

In a further preferred embodiment the polyether polyol used as component (B) has an average functionality of, for example, from 1 to 6, preferably from 2 to 5, particularly preferably from 3 to 4.5.

Component (B) is generally present in an amount of from 10 to 50% by weight, preferably from 20 to 40% by weight, particularly preferably from 25 to 35% by weight, in each case based on the sum of the components (A), (B), (C) and (E), in the polyurethane foam of the invention.

Component (C):

At least one polyester polyol is present as component (C) in the polyurethane foam of the invention.

The polyester polyols used as component (C) are preferably prepared by condensation of polyfunctional alcohols, preferably diols, having from 2 to 12 carbon atoms, preferably from 2 to 6 carbon atoms, for example ethylene glycol, diethylene glycol, butanediol, trimethylolpropane, glycerol or pentaerythritol, with polyfunctional carboxylic acids having from 2 to 12 carbon atoms, for example succinic acid, glutaric acid, adipic acid, suberic acid, azelaic acid, sebacic acid, decanedicarboxylic acid, maleic acid, fumaric acid and preferably phthalic acid, isophthalic acid, terephthalic acid, recycled polyethylene terephthalate and the isomers of naphthalenedicarboxylic acids or anhydrides thereof.

Particular preference is given to polyesterols, prepared from phthalic anhydride and/or terephthalic acid and/or recycled polyethylene terephthalate. As further starting materials in the preparation of the polyesters, it is also possible to make concomitant use of hydrophobic materials. The hydrophobic materials are water-insoluble materials which comprise a nonpolar organic radical and also have at least one reactive group selected from among hydroxyl, carboxylic acid, carboxylic ester and mixtures thereof. The equivalent weight of the hydrophobic materials is in the range from 130 to 1000 g/mol. For example, it is possible to use fatty acids such as stearic acid, oleic acid, palmitic acid, lauric acid or linoleic acid, and also fats and oils, such as for example castor oil, corn oil, sunflower oil, coconut oil, olive oil or tall oil. If polyesters comprise hydrophobic materials, the proportion of the hydrophobic materials based on the total monomer content of the polyesterol is preferably from 1 to 30 mol %, particularly preferably from 4 to 15 mol %.

In a particularly preferred embodiment, a polyester polyol made up of phthalic anhydride, diethylene glycol and oleic acid is present as component (C).

The polyester polyols used according to the invention as component (C) have a functionality of generally from 1.5 to 8, preferably from 1.5 to 5, particularly preferably from 1.5 to 3.

The polyester polyols used according to the invention as component (C) generally have hydroxyl numbers of from 100 mg KOH/g to 850 mg KOH/g, preferably from 100 mg KOH/g to 400 mg KOH/g and in particular from 150 mg KOH/g to 300 mg KOH/g.

Component (C) is generally present in an amount of from 10 to 50% by weight, preferably from 20 to 40% by weight, particularly preferably from 25 to 35% by weight, in each case based on the sum of the components (A), (B), (C) and (E), in the polyurethane foam of the invention.

Component (D):

At least one polyisocyanate is present as component (D) in the polyurethane foam of the invention. For the purposes of the present invention, the customary aliphatic, cycloaliphatic and in particular aromatic diisocyanates and/or polyisocyanates can be used as polyisocyanate.

Specific examples which may be mentioned are tolylene 2,4- and 2,6-diisocyanate (TDI) and the corresponding isomer mixtures, diphenylmethane 4,4′-, 2,4′- and 2,2′-diisocyanate (MDI) and the corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylenepolymethylene polyisocyanates (crude MDI) and mixtures of crude MDI and tolylene diisocyanates. The organic diisocyanates and polyisocyanates can be used individually or in the form of mixtures.

Use is frequently also made of modified polyfunctional isocyanates, i.e. products obtained by chemical reaction of organic diisocyanates and/or polyisocyanates. Examples which may be mentioned are diisocyanates and/or polyisocyanates comprising isocyanurate and/or urethane groups. The modified polyisocyanates can optionally be mixed with one another or with unmodified organic polyisocyanates such as diphenylmethane 2,4′-, 4,4′-diisocyanate, crude MDI, tolylene 2,4- and/or 2,6-diisocyanate.

In addition, it is also possible to use reaction products of polyfunctional isocyanates with polyhydric polyols and also mixtures thereof with other diisocyanates and polyisocyanates.

Crude MDI having an NCO content of from 29 to 33% by weight has been found to be particularly useful as organic polyisocyanate.

In a preferred embodiment, the polyisocyanate is selected so that it has a viscosity of less than 1000 mPas, preferably from 100 to 1000 mPas, particularly preferably from 120 to 1000 mPas, measured in accordance with DIN 53019 at 20° C.

In a further preferred embodiment the polyisocyanate used as component (D) has an average functionality of, for example, from 1 to 6, preferably from 2 to 4, particularly preferably from 2.5 to 3.5.

In a particularly preferred embodiment, a mixture of diphenylmethane 1,4′-diisocyanate with higher-functional oligomers and isomers (crude MDI), having an NCO content of from 20 to 40% by mass, preferably from 25 to 35% by mass, for example 31.5% by mass, and an average functionality of from 2 to 4, preferably from 2.5 to 3.5, for example about 2.7, is present as component (D).

Component (D) is generally present in an amount of from 100 to 250% by weight, preferably from 160 to 200% by weight, particularly preferably from 170 to 190% by weight, in each case based on the sum of the components (A), (B), (C) and (E), in the polyurethane foam of the invention.

Component (E):

The polyurethane foam of the invention is obtained by reacting the above-mentioned components (A), (B), (C) and (D) in the presence of at least one catalyst selected from the group consisting of salts of carboxylic acids having from 1 to 20 carbon atoms, amine-comprising compounds and mixtures thereof as component (E).

The compounds mentioned as catalysts are known per se to those skilled in the art and are commercially available.

In one embodiment of the polyurethane foam of the invention, salts of carboxylic acids having from 1 to 20 carbon atoms which preferably catalyze the crosslinking reaction to form allophanates, biurets or the trimerization to form isocyanurates are used as catalyst in the production of the foam.

Examples of suitable salts are metal salts, especially ammonium salts, alkali metal salts, for example Li, Na, K, Rb or Cs salts, or alkaline earth metal salts, for example Be, Mg, Ca, Sr or Ba salts, of the corresponding carboxylic acids. Preference is given to using the salts of linear or branched, substituted or unsubstituted, saturated or unsaturated, aliphatic or aromatic carboxylic acids having 1 to 20 carbon atoms, for example selected from the group consisting of formic acid, acetic acid, octanoic acid, tartaric acid, citric acid, oleic acid, stearic acid, ricinoleic acid and mixtures thereof, or substituted or unsubstituted, aromatic carboxylic acids having from 6 to 20 carbons, for example selected from the group consisting of benzoic acid, salicylic acid and mixtures thereof. Suitable substituents are, for example, hydroxy and/or amino groups.

Particularly preferred catalysts of this embodiment are selected from the group consisting of potassium formate, potassium acetate, potassium octoate, ammonium octoate, 2-hydroxy-N,N,N-trimethyl-1-propanammonium formate, trimethylhydroxypropylammonium formate and mixtures thereof.

In a further embodiment of the invention, it is possible to use amine-comprising compounds which likewise catalyze the reaction to form allophanates, biurets or the trimerization to form isocyanurates as catalysts. Amine-comprising compounds which are preferred according to the invention are, for example, selected from the group consisting of N,N′,N″-tris(dimethylaminopropyl)hexahydrotriazine (CAS 15875-13-5), tris-3-dimethylaminopropylamine, pentamethyldiethylenetriamine, pentamethyldipropylenetriamine, trimethylaminoethylethanolamine, dimethylaminoethoxyethanol, 2,4,6-tris(dimethylaminoethyl)phenol and mixtures thereof.

In this embodiment, N,N′,N″-tris(dimethylaminopropyl)hexahydrotriazine is particularly preferred.

The present invention thus particularly preferably provides the polyurethane foam of the invention in which the at least one catalyst used as component (E) is selected from the group consisting of potassium formate, potassium acetate, potassium octoate, ammonium octoate, 2-hydroxy-N,N,N-trimethyl-1-propanammonium formate, trimethylhydroxypropylammonium formate, N,N′,N″-tris(dimethylaminopropyl)-hexahydrotriazine, tris-3-dimethylaminopropylamine, pentamethyldiethylenetriamine, pentamethyldipropylenetriamine, trimethylaminoethylethanolamine, dimethylaminoethoxyethanol, 2,4,6-tris(dimethylaminoethyl)phenol and mixtures thereof.

Apart from the abovementioned catalysts (component (E)) it is also possible, according to the invention, to make additional use of further catalysts which strongly accelerate the reaction of the isocyanate groups with the groups which are reactive toward isocyanate groups. Such catalysts are, for example, strongly basic amines, such as tertiary aliphatic amines, imidazoles, amidines, and alkanolamines.

Component (E) is generally present in an amount of from 0.1 to 5% by weight, preferably from 0.2 to 3% by weight, particularly preferably from 0.3 to 2% by weight, in each case based on the sum of the components (A), (B), (C) and (E), in the polyurethane foam of the invention. If a mixture of catalysts is used, the amounts specified apply to this mixture.

It is important for the purposes of the invention that the polyurethane foam of the invention is produced in the presence of the catalysts specified. A particularly advantageous combination of low thermal conductivity and good thermal stability is achieved by this means and by interaction of the specific components (A), (B), (C) and (D) in conjunction with the specific ISO index.

Component (F):

According to the invention, the blowing agents known to those skilled in the art, for example water and/or carboxylic acids, in particular formic acid which reacts with isocyanate groups to eliminate carbon dioxide, can generally be used as blowing agent (component (F)). It is also possible to use physical blowing agents in combination with or in place of water. These are compounds which are inert toward the starting components and are usually liquid at room temperature and vaporize under the conditions of the urethane reaction. The boiling point of these compounds is preferably below 50° C. Physical blowing agents also include compounds which are gaseous at room temperature and are introduced under pressure into the starting component or are dissolved therein, for example carbon dioxide, low-boiling alkanes and fluoroalkanes. The compounds are usually selected from the group consisting of alkanes and/or cycloalkanes having at least 4 carbon atoms, dialkyl ethers, esters, ketones, acetals, fluoroalkanes having from 1 to 8 carbon atoms, and tetraalkylsilanes having from 1 to 3 carbon atoms in the alkyl chain, in particular tetramethylsilane. Examples which may be mentioned are propane, n-butane, isobutane and cyclobutane, n-pentane, isopentane and cyclopentane, cyclohexane, dimethyl ether, methyl ethyl ether, methyl butyl ether, methyl formate, acetone, and also fluoroalkanes which can be degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, difluoroethane and heptafluoropropane. The physical blowing agents mentioned can be used either alone or in any combination with one another.

Component (F) is generally present in an amount of from 2 to 25% by weight, preferably from 10 to 20% by weight, in each case based on the sum of the components (A), (B), (C) and (E), in the polyurethane foam of the invention.

In addition to the abovementioned components, the polyurethane foam of the invention may optionally comprise further additives known per se to those skilled in the art, for example crosslinkers. According to the invention, a crosslinker is a compound which has a molecular weight of from 60 to 400 g/mol and at least 3 hydrogen atoms which are reactive toward isocyanates. An example of such a compound is glycerol.

The crosslinkers are generally used in an amount of from 1 to 10% by weight, preferably from 2 to 6% by weight, based on the sum of the components (A), (B), (C) and (E). In a further embodiment, the polyurethane foam of the invention can comprise at least one chain extender. For the purposes of the present invention, chain extenders are compounds which have a molecular weight of from 60 to 400 g/mol and have 2 hydrogen atoms which are reactive toward isocyanates. Examples of such compounds are butanediol, diethylene glycol, dipropylene glycol and ethylene glycol.

The chain extenders are generally used in an amount of from 2 to 20% by weight, based on the sum of the components (A), (B), (C) and (E).

Crosslinkers and chain extenders can be used either individually or in combination.

Further additives are, for example, selected from the group consisting of surface-active substances, stabilizers, for example foam stabilizers, cell regulators, fillers, dyes, pigments, flame retardants, antistatics, hydrolysis inhibitors, fungistatic and bacteriostatic substances and mixtures thereof.

Suitable flame retardants are generally the flame retardants known from the prior art, for example brominated ethers (Ixol), brominated alcohols such as dibromoneopentyl alcohol, tribromoneopentyl alcohol and PHT-4-diol and also chlorinated phosphates such as tris(2-chloroethyl) phosphate, tris(2-chloroisopropyl) phosphate (TCPP), tris(1,3-dichloroisopropyl) phosphate, tris(2,3-dibromopropyl) phosphate and tetrakis(2-chloroethyl)ethylenediphosphate.

As further liquid halogen-free flame retardants, it is possible to use diethyl ethanephosphonate (DEEP), triethyl phosphate (TEP), dimethyl propylphosphonate (DMPP), diphenyl cresyl phosphate (DPC) and others.

For the purposes of the present invention, the flame retardants are used in an amount of from 0 to 65% by weight, preferably from 0 to 60% by weight, more preferably from 0 to 50% by weight, based on the sum of the components (A), (B), (C) and (E). If flame retardants are present according to the invention, these are used in an amount of from 2 to 65% by weight, preferably from 5 to 60% by weight, more preferably from 5 to 50% by weight, based on the sum of the components (A), (B), (C) and (E).

It is also important for the purposes of the invention that the ratio of OCN groups to OH groups, known as the ISO index, in the reaction mixture for producing the polyurethane foam of the invention is from 140 to 180, preferably from 145 to 165, particularly preferably from 150 to 160. This specific ISO index in combination with the other specified features which are important to the invention results in a polyurethane foam which has a particularly advantageous combination of low thermal conductivity and thermal stability being obtained.

The present invention also provides a process for producing a polyurethane foam according to the invention, which comprises at least the following steps:
(I) contacting of the components (A), (B), (C), (D), (E) and (F) to give a reaction product and
(II) foaming of the reaction product obtained in step (I).

Processes for producing polyurethane foams are known per se to those skilled in the art. For example, the polyurethane foam of the invention can be produced batchwise or continuously by the prepolymer process or preferably by the one-shot process with the aid of known mixing apparatuses (steps (I) and (II)).

It has been found to be particularly advantageous to employ the two-component process and to mix the formative components (A), (B), (C), (E) and (F) in step (I) to give a polyol component, react this with the polyisocyanates (D) and foam this mixture in step (II). A summary overview of the production of polyurethane foams and their use as covering layer or preferably core layer in composite elements and also their use as insulation layer in cooling or heating technology has been published, for example, in the corresponding chapter(s) of Kunststoffhandbuch, volume 7 “Polyurethane”, edited by Günter Oertel, Carl-Hanser-Verlag Munich, 1st edition, 1966, 2nd edition, 1983 and 3rd edition, 1993.

Furthermore, the present invention also comprises the use of the polyurethane foam of the invention for insulation, in particular pipe insulation.

The polyurethane foam of the invention is preferably used for insulation of pipes, for example district heating pipes.

In a preferred embodiment, the polyurethane system of the invention is used for insulation of insulated composite jacketed pipes for district heating networks laid in the ground in accordance with DIN EN 253.

The invention further provides an insulated pipe comprising a polyurethane foam according to the invention. The insulated pipe of the invention is, for example, made up of
i) a pipe for a medium,
ii) a layer of insulation material comprising the polyurethane foam of the invention, and
iii) an outer pipe.

The pipe (i) for a medium is generally a steel pipe having an external diameter of from 1 to 120 cm, preferably from 4 to 110 cm and a length from 1 to 24 meters, preferably from 6 to 16 meters.

A layer of insulation material (ii), comprising the polyurethane foam of the invention is arranged on the outside of the pipe for a medium. This layer generally has a thickness of from 1 to 10 cm, preferably from 2 to 5 cm.

In a preferred embodiment, the layer of insulation material has an overall bulk density of less than 90 kg/m³, preferably from 70 to 87 kg/m³. For the present purposes, the overall bulk density is the bulk density distribution over the pipe cross section and the pipe length.

In a further preferred embodiment, the layer of insulation material (ii), comprising the polyurethane foam of the invention, has a thermal conductivity of less than 27 mW/mK, preferably from 22 to 26.9, measured in accordance with EN ISO 8497.

The outer pipe (iii) surrounds the layer of insulation material and generally comprises plastic, for example polyethylene, and usually has a thickness of from 1 to 30 mm. The internal diameter of the outer pipe is generally from 6 to 140 cm, preferably 10 to 120 cm.

The outer pipe (iii) may optionally comprise a plurality of layers which are combined in the extrusion operation. An example of this is the introduction of multilayer films between polyurethane foam and PE sheath, with the film comprising at least one metallic layer to improve the barrier action. Suitable outer pipes of this type are described in EP-A-960 723.

In a particularly preferred embodiment, the insulated pipe is an insulated composite jacketed pipe for district heating networks laid in the ground, which pipe meets the requirements of DIN EN 253.

### EXAMPLES

The invention is illustrated by the following examples. Formulations 1-2 are according to the invention, 3-5 are comparative formulations

| Example | 1 | 2 | C3 | C4 | C5 |
|---|---|---|---|---|---|
| Polyether A | 18.4 | 18.5 | 36 | 18.55 | 18.4 |
| Polyether B | 12 | 12 | 55.15 | 12 | 12 |
| Polyether C | 30 | 30 | | 30 | 30 |
| Polyether D | 5 | 5 | | 5 | 5 |
| Polyester A | 30 | 30 | | 30 | 30 |
| DPG | | | 4 | | |
| Stabilizer | 2 | 2 | 2 | 2 | 2 |
| Cat 1 | 0.2 | 0.15 | 0.95 | 0.15 | 0.5 |
| Cat 2 | | 0.25 | | 0.3 | |
| Cat 3 | 0.3 | | | | |
| Water | 2.1 | 2.1 | 1.9 | 2 | 2.1 |
| Total | 100 | 100 | 100 | 100 | 100 |
| c-Pentane | 14 | 14 | 15 | 13 | 14 |
| IsoPMDI 92140 | 182 | 182 | 176 | 153 | 182 |
| Iso index | 155 | 156 | 128 | 132 | 156 |
| Foam density, | 39 | 40 | 37 | 38 | 39 |
| cup (g/l) | | | | | |
| Thermal | 25.5 | — | 27.5 | 25.2 | — |
| conductivity | | | | | |
| λ₅₀ (mW/mK) | | | | | |
| Glass | 195 | 195 | 190 | 178 | 180 |
| transition | | | | | |
| temperature | | | | | |
| tanδ (° C.) | | | | | |
| Flask test, | un- | un- | un- | carbon- | carbon- |
| 40 days at | changed | changed | changed | ization | ization |
| 180° C. | | | | | |

Polyether A: started by means of sucrose, pentaerythritol and diethylene glycol, alkoxylated with PO; OH number = 403 mg KOH/g, functionality = 3.9
Polyether B: started by means of sorbitol, alkoxylated with PO; OH number = 490 mg KOH/g, functionality = 4.9
Polyether C: started by means of TDA, alkoxylated with PO and EO; OH number = 390 mg KOH/g, functionality = 3.8
Polyether D: started by means of glycerol, alkoxylated with PO; OH number = 805 mg KOH/g, functionality = 3
Polyester A: esterification product of phthalic anhydride, diethylene glycol and oleic acid, OH number = 210 mg KOH/g, functionality = 2
DPG: dipropylene glycol, OH number = 840 mg KOH/g; functionality = 2
Stabilizer based on silicone (L 6900 from Momentive)
Cat 1: dimethylcyclohexylamine
Cat 2: N,N′,N″-tris(dimethylaminopropyl)hexahydrotriazine
Cat 3: potassium acetate (47% in ethylene glycol)
IsoPMDI 92140 from BASF SE, mixture of diphenylmethane 1,4′-diisocyanate with higher-functional oligomers and isomers (crude MDI), having an NCO content of 31.5% by mass and an average functionality of about 2.7.

The table shows that the thermal conductivity can be significantly improved at a constant thermal stability by the use of a rigid PU foam system according to the invention.

Analytical Methods:

The determination of the thermal conductivity of composite jacketed pipes DN 50 was carried out in accordance with DIN EN 253:2006-02, appendix G and ISO 8497.

Aluminum flasks are filled manually with foam in an amount of 210 g (corresponds to a foam density of 80 kg/m³). Screw caps served to seal the flasks completely. The foamed aluminum flasks are stored at 180° C. for from 30 to 40 days. After sawing open the aluminum flasks, changes in the color and cell structure are assessed visually.

The glass transition temperature was measured by means of dynamic mechanical analysis (DMA). The maximum of the loss factor tan δ was taken as the glass transition temperature.

1. A polyurethane foam, which can be obtained by reacting
(A) at least one polyether polyol as component (A),
(B) at least one polyether polyol based on at least one amine as component (B),
(C) at least one polyester polyol as component (C) and
(D) at least one polyisocyanate as component (D),
in the presence of at least one catalyst selected from the group consisting of salts of carboxylic acids having from 1 to 20 carbon atoms, amine-comprising compounds and mixtures thereof as component (E) and at least one blowing agent as component (F), wherein the ratio of OCN groups to OH groups (ISO index) is from 140 to 180.

2. The polyurethane foam according to claim 1, wherein the at least one polyether polyol (component (A)) is based on at least one compound selected from the group consisting of trimethylolpropane, glycerol, pentaerythritol, sugar compounds such as glucose, sorbitol, mannitol and sucrose, polyhydric phenols, resols, such as for example oligomeric condensation products of phenol and formaldehyde and Mannich condensates of phenols, formaldehyde and dialkanolamines, melamine and mixtures thereof.

3. The polyurethane foam according to claim 1, wherein the at least one amine in component (B) is toluenediamine (TDA).

4. The polyurethane foam according to claim 1, wherein a mixture comprising at least one polyether polyol based on a polysaccharide sugar (a1), at least one polyether polyol based on a monosaccharide sugar (a2) and at least one polyether polyol based on at least one at least dihydric alcohol (a3) is used as component (A).

5. A process for producing a polyurethane foam according to claim 1, which comprises at least the following steps:
(I) contacting of the components (A), (B), (C), (D), (E) and (F) to give a reaction product and
(II) foaming of the reaction product obtained in step (I).

6. The method of using a polyurethane foam according to claim 1 for insulation.

7. The method according to claim 6, wherein the insulation is pipe insulation.

8. An insulated pipe comprising a polyurethane foam according to claim 1.
